(19) United States
(12) Patent Application Publication
(10) Pub. No.: US 2013/0293605 A1
(43) Pub. Date: Nov. 7, 2013

(54) SYSTEM AND METHOD FOR DETECTING WRINKLES IN A PRINT MEDIUM

(71) Applicants: Yaron Bar-Tal, Ganel Tikveh (IL); Efraim Barhum, Moshav Hagor (IL)

(72) Inventors: Yaron Bar-Tal, Ganel Tikveh (IL); Efraim Barhum, Moshav Hagor (IL)

(21) Appl. No.: 13/869,176

(22) Filed: Apr. 24, 2013

(30) Foreign Application Priority Data
May 1, 2012 (IL) 219812

(51) Int. Cl. B41J 2/045

(52) U.S. Cl. CPC B41J 2/04556
USPC 347/8

(57) ABSTRACT

An inkjet printer comprising a print table and a carriage that reciprocates across the print table, wherein the carriage comprises print-heads and further comprises a distance gauge mounted on the carriage for monitoring the distance between the carriage and a medium thereunder on the print table.

### FIELD OF THE INVENTION

The present invention is directed to a system and associated method for detecting wrinkles in a medium to be printed upon, particularly but not exclusively in wide format printers.

### BACKGROUND OF THE INVENTION

Wide format inkjet printing is commonly used for printing posters, wall decorations, signs and the like. Sometimes, particularly when printing onto a rigid material, the material to be printed is provided in sheet form and the printing technique is known as flat-bed printing. The medium to be printed, if flexible, is typically provided on a continuous roll and is advanced, roll to roll, past the print head.

Wide and super wide digital printers have a print head box or carriage that reciprocates from side to side across a wide or super wide printing table that may be 3, 5 or even 10 meters wide.

Particularly when printing wide onto very wide rolls of flimsy media, the media may wrinkle.

Wrinkles may be caused by creases in the medium itself or by some flaw in the media advancing mechanism.

Wrinkling can adversely affect the quality of the printing. In inkjet printing, wrinkling may cause the carriage to collide with the wrinkles of the medium. This may ruin the printing and in severe cases, may damage the carriage and/or the print heads.

There is a need for systems and methods that detect wrinkling so that the effects thereof can be minimized, and the present invention addresses this need.

### SUMMARY OF THE INVENTION

A first aspect of the invention is directed to providing an inkjet printer comprising a print table and a carriage that reciprocates across the print table, wherein the carriage comprises print-heads and further comprises a distance gauge mounted on the carriage for monitoring the distance between the carriage and a medium under the carriage on the print table.

Typically, the inkjet printer further comprises a control computer, wherein the distance gauge is configured to provide a signal to the control computer responsive of changes in distance between the carriage and the medium as the carriage rasters from across the medium.

In some embodiments, the inkjet printer is configured to perform an action responsive to changes in distance beyond acceptable tolerances.

The action may be selected from the group comprising: (i) stopping the rastering and printing; (ii) raising the carriage with respect to the print table; (iii) tensioning the medium, and (iv) applying a negative air pressure on the medium opposite the carriage to suck the medium against the print-table.

The distance gauge may comprise a mechanical profilometer.

Typically, the distance gauge comprises a laser profilometer.

Optionally, the distance gauge comprises an optical profilometer.

Where the distance gauge comprises an optical profilometer it may use at least one principle selected from the group consisting of: Vertical Scanning Interferometry/White-light interferometery; Phase Shifting Interferometry; Differential interference contrast microscopy (Nomarski Microscopy); Focus detection methods; Intensity Detection; Focus variation; Differential Detection; Critical Angle Method; Astigmatic Method; Focault Method; Confocal microscopy; Pattern projection Methods; Fringe projection; Fourier Profilometry, and Moire.

A second aspect of the invention is directed to a method of detecting wrinkles in a medium being printed by an inkjet printer comprising a print table, a carriage that reciprocates across the print table carrying print-heads and a control computer, the method comprising: mounting at least one distance gauge on the carriage; monitoring a distance between the carriage and a medium under the carriage on the print table; detecting differences, and signaling the control computer regarding changes in distance between the carriage and the medium as the carriage rasters from across the medium.

The method may further comprise the step of performing an action responsive to a change in distance beyond an acceptable tolerance.

The action may be selected from the group consisting of: (i) stopping the rastering and printing; (ii) raising the carriage with respect to the print table; (iii) tensioning the medium, and (iv) applying a negative air pressure on the medium opposite the carriage to suck the medium against the print-table.

In some embodiments the at least one distance gauge comprises a laser profilometer and the method comprises monitoring a Doppler effect.

In some embodiments the at least one distance gauge comprises a laser profilometer and the method comprises laser triangulation.

In some embodiments the at least one distance gauge comprises an optical profilometer.

In some embodiments the method comprises performing an image analysis to detect variation in height.

In some embodiments, the image analysis comprises one of the group consisting of: Vertical Scanning Interferometry/White-light interferometery; Phase Shifting Interferometry; Differential interference contrast microscopy (Nomarski Microscopy); Focus detection methods; Intensity Detection; Focus variation; Differential Detection; Critical Angle Method; Astigmatic Method; Focault Method; Confocal microscopy; Pattern Projection Methods; Fringe projection; Fourier Profilometry, and Moire.

The printer is typically a wide format printer, having a printing width of at least 0.5 m, and optionally 3 m, 5 m or 10 m.

Typically, the printer is selected from the group comprising flat bed printers, roll to roll printers and dual mode printers.

The medium may be a flexible medium and the topography is a wrinkle.

The medium may be a rigid medium and the topography is a flaw in a surface of the medium.

The medium may be a rigid medium having a three dimensional upper surface.

### BRIEF DESCRIPTION OF FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a schematic side view of one embodiment of the invention, and

FIG. 2 is a flow chart of a method of the invention.

### DESCRIPTION OF EMBODIMENTS

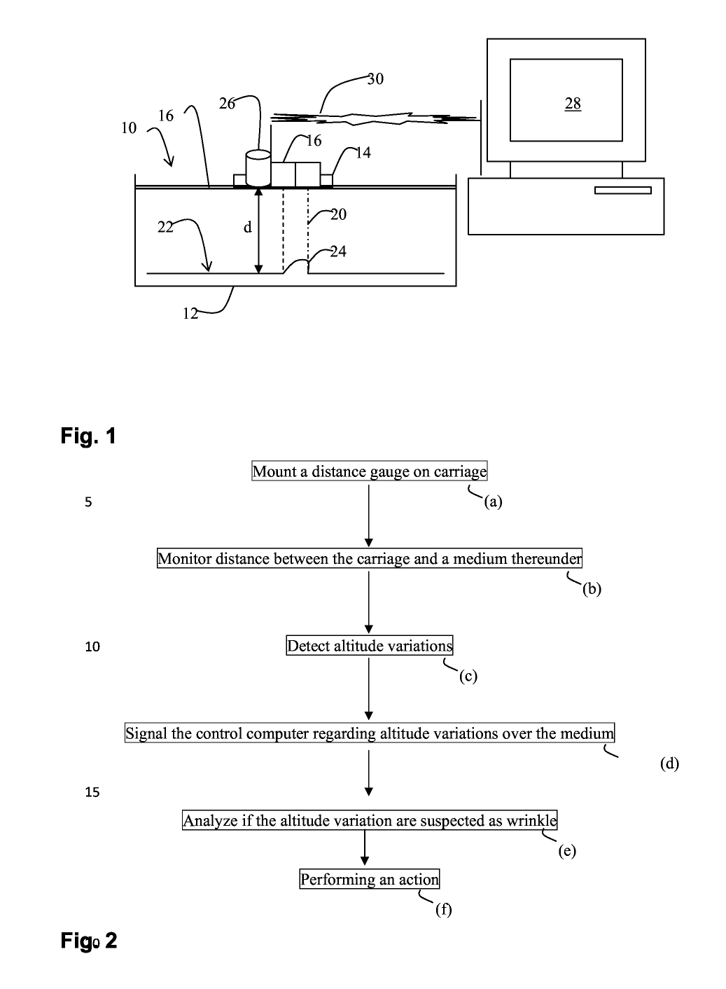

With reference to FIG. 1, an inkjet printer 10, such as a wide format or super wide format inkjet printer, may consist of a print table 12 and a carriage 14 that reciprocates along a track 16 over the print table 12. The carriage 14 carries print-heads 18 which jet ink 120 onto a medium 22 over the print table 12. The medium 22 may be advanced over the print table 12, such as when fed over rollers, as is commonly the case with flexible media, which is typically supplied as roll stock.

Alternatively, with flat bed printing, the track 16 may be moved down a relatively long print table.

To ensure quality printing, the height of the print-heads 18 over the medium 22 is generally carefully set at the beginning of a print job. It has been found however, that sometimes a medium will include one or more wrinkles 24, i.e. folds, ridges or creases, where due to flaws in the medium 22 or in the forwarding means, there is a change in height across the width of the medium 22.

Embodiments are provided with a distance gauge 26 mounted on the carriage 14, for monitoring the distance ‘d’ between the carriage 14 and the medium 22 thereunder on the print table 12.

The inkjet printer 10 includes a control computer 28 and the distance gauge 26 may be configured to provide a signal 30 to the control computer 28 responsive of changes in distance between the carriage 14 and the medium 22 as the carriage 14 rasters back and forth across the medium 22.

In some embodiments, the inkjet printer 10 or the distance gauge 26 is configured to provide an alert if a winkle is detected. In other embodiments and configurations, inkjet printer 10 is configured to perform an action responsive to changes in distance ‘d’ beyond acceptable tolerances.

The action may be to stopping the printing, including halting the rastering of the carriage and the jetting of ink from the print-heads 18. The action may include changing the altitude d of the carriage 14 with respect to the print table 12 to follow variations in altitude d. The action may include varying the tension of the medium 22 to stretch out creases. Where the print table 12 is a vacuum table, a negative air pressure may be applied to the medium 22 opposite the carriage 14 to suck the medium 22 against the print-table 12, flattening the medium opposite the print-heads 18.

The distance gauge 26 may be a mechanical profilometer that touches the medium and monitors its topography. In such cases, the profilometer should be configured to lead the print heads 18, so as not to smudge the ink printed on the medium 22.

Typically however, the distance gauge 26 includes a laser profilometer which may monitor altitude variation by the Doppler effect or by laser triangulation.

In some embodiments, the distance gauge 26 includes an optical profilometer. There are a very large number of optical profilometers available that use different and well established optical principles. For example, an optical profilometer may use at least one of the following principles: Vertical Scanning Interferometry/White-light interferometery; Phase Shifting Interferometry; Differential interference contrast microscopy (Nomarski Microscopy); Focus detection methods; Intensity Detection; Focus variation; Differential Detection; Critical Angle Method; Astigmatic Method; Focault Method; Confocal microscopy; Pattern projection Methods; Fringe projection; Fourier Profilometry, and Moire.

These principles are well known in the art of profilometry and for simplicity, are not detailed here.

The appropriate technique is dependent on the nature, reflectance/absorption, color and texture of the media, and usefully, the inkjet printer 10 will be provided with appropriate algorithms to apply more than one optical profiling principle, and may be configured to select an appropriate profiling principle or to apply more than one profiling principle, and to select the most appropriate or to average the results of several measurements made using different principles that give an acceptable result.

Particularly where the distance gauge 26 is a laser distance gauge or some other fairly simple device, it may include a dedicated hardware computing device such as a Programmable Logic Controller that may include a processor or dedicated electronic circuit etc. In such cases, distance information is transferred to the main processor as input that may be used to make appropriate adjustments thereto.

Apart from alerting that there is a discrepancy beyond predetermined tolerances, the gauge has to interact with the control computer 28 processor of the printer 10, of course.

The need for monitoring height variation or wrinkling is particularly important when printing onto fabrics, polymer films and other flexible media, which may be easily folded and creased. It is particularly important when printing wide media, such as a medium having a width of 0.5 m. In wide format and super wide format inkjet printing, flexible media as wide as 3, 5 or even 10 m may be printed, and wrinkles and folds may not merely spoil the quality of the printing, but may also contact the carriage 14 and/or damage the print-heads 18.

A distance gauge 26 mounted on the carriage 14 may be useful for printing onto rigid media as well, where a blister, hollow or other local height variation may adversely affect the print quality and possibly interfere with the functioning or damage the printer 10.

With additional reference to FIG. 2, a method for detecting wrinkles 24 in a medium 22 being printed by an inkjet printer 10 comprising a print table 12, a carriage 14 that reciprocates across the print table 12 carrying print-heads 18, and a control computer 28 for controlling the printer 10, the method comprising: mounting at least one distance gauge 26 on the carriage 14—step (a); monitoring a distance ‘d’ between the carriage 14 and a medium 22 under the print-head on the print table 12—step (b); detecting differences—step (c), and signaling the control computer 28 regarding changes in distance between the carriage and the medium as the carriage rasters from across the medium—step (d). Where differences are detected, they may be analyzed to detect a wrinkle or to identify another cause of height variation. The method may further comprise the step of performing an action—step (f) responsive to a change in distance beyond an acceptable tolerance.

The action may be selected from the group consisting of: (i) alerting; (ii) stopping the rastering and printing; (iii) raising the carriage 14 with respect to the print table 12; (iv) tensioning the medium 22, and (v) applying a negative air pressure on the medium 22 opposite the carriage 14 to suck the medium 22 against the print-table 12.

The appropriate action may be dependent of the nature of the fault, or independent thereof. Thus raising and lowering the carriage 14 to follow the topography of the medium 22 may ensure quality printing regardless of the nature of change in topography, whereas applying a negative air pressure on the medium 22 opposite the carriage 14 to suck the medium 22 against the print-table 12 may only be of value if a wrinkly is detected, and may be counterproductive if there is a fold that doubles the material over itself, for example.

The printer is typically a wide format printer, having a printing width of at least 0.5 m, and optionally 1.2 m, 1.6 m, 1.8 m, 2 m, 3 m, 5 m or any other sizes in such ranges, and may be a flat bed printer, a roll to roll printer or a dual mode printer.

The topography may be a wrinkle 24 or fold in a flexible medium 22 such as a film or a fabric. It may be a flaw in a rigid medium, or may be a three dimensional surface.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. An inkjet printer comprising a print table and a carriage that reciprocates across the print table, wherein the carriage comprises print-heads and further comprises a distance gauge mounted on the carriage for monitoring the distance between the carriage and a medium under the carriage on the print table.

2. The inkjet printer of claim 1 further comprising a control computer, wherein the distance gauge is configured to provide a signal to the control computer responsive of changes in distance between the carriage and the medium as the carriage rasters from across the medium.

3. The inkjet printer of claim 2, wherein the control computer is configured to perform an action responsive of changes in distance beyond acceptable tolerances.

4. The inkjet printer of claim 3, wherein the action is selected from the group comprising:
(i) stopping the rastering and printing;
(ii) raising the carriage with respect to the print table;
(iii) tensioning the medium, and
(iv) applying a negative air pressure on the medium opposite the carriage to suck the medium against the print-table.

5. The inkjet printer of claim 1, wherein the distance gauge comprises a mechanical profilometer.

6. The inkjet printer of claim 1, wherein the distance gauge comprises a laser profilometer.

7. The inkjet printer of claim 1, wherein the distance gauge comprises an optical profilometer.

8. The inkjet printer of claim 1, wherein the optical profilometer uses at least one principle selected from the group consisting of:
Vertical Scanning Interferometry/White-light interferometery;
Phase Shifting Interferometry;
Differential interference contrast microscopy (Nomarski Microscopy);
Focus detection methods;
Intensity Detection;
Focus variation;
Differential Detection;
Critical Angle Method;
Astigmatic Method;
Focault Method;
Confocal microscopy;
Pattern projection Methods;
Fringe projection;
Fourier Profilometry, and
Moire.

9. The inkjet printer of claim 1 for printing onto a medium having a width of 0.5 m.

10. A method of detecting a topography in a medium being printed by an inkjet printer comprising a print table, a carriage that reciprocates across the print table carrying print-heads and a control computer, the method comprising:
mounting a distance gauge on the carriage;
monitoring distance between the carriage and a medium under the carriage on the print table;
detecting differences, and
signaling the control computer regarding changes in distance between the carriage and the medium as the carriage rasters from across the medium.

11. The method of claim 10, further comprising performing an action responsive to a change in distance beyond an acceptable tolerance.

12. The method of claim 10, wherein the action is selected from the group comprising:
(i) stopping the rastering and printing;
(ii) raising the carriage with respect to the print table;
(iii) tensioning the medium, and
(iv) applying a negative air pressure on the medium opposite the carriage to suck the medium against the print-table.

13. The method of claim 10, wherein the distance gauge comprises a laser profilometer and the method comprises monitoring a Doppler effect.

14. The method of claim 10, wherein the distance gauge comprises a laser profilometer and the method comprises laser triangulation.

15. The method of claim 10, wherein the distance gauge comprises an optical profilometer.

16. The method of claim 15, comprising performing an image analysis to detect variation in height.

17. The method of claim 16, wherein the image analysis comprises one of the group consisting of: Vertical Scanning Interferometry/White-light interferometery; Phase Shifting Interferometry; Differential interference contrast microscopy (Nomarski Microscopy); Focus detection methods; Intensity Detection; Focus variation;
Differential Detection; Critical Angle Method; Astigmatic Method;
Focault Method; Confocal microscopy; Pattern Projection Methods; Fringe projection; Fourier Profilometry, and Moire.

18. The method of claim 10 wherein the medium is a flexible medium and the topography is a wrinkle.

19. The method of claim 10 wherein the medium is a rigid medium and the topography is a flaw in a surface of the medium.

20. The method of claim 10 wherein the medium is a rigid medium having a three dimensional upper surface.
